(19) United States
(12) Patent Application Publication
(10) Pub. No.: US 2023/0334603 A1
(43) Pub. Date: Oct. 19, 2023

(54) APPARATUS AND METHODS FOR DATA COMMUNICATION AMONG NETWORKED DEVICES

(71) Applicant: BULLDOG ADJUSTERS, LLC, Plantation, FL (US)

(72) Inventors: Shlome JUNIK, Miami, FL (US); Aaron Singer, Aventura, FL (US); Vince Lefton, Coral Springs, FL (US); Chaim Kitchner, Hollywood, FL (US)

(73) Assignee: BULLDOG ADJUSTERS, LLC, Plantation, FL (US)

(21) Appl. No.: 18/300,485

(22) Filed: Apr. 14, 2023

Related U.S. Application Data
(60) Provisional application No. 63/331,036, filed on Apr. 14, 2022.

(51) Int. Cl. G06Q 50/16; G06Q 10/20; G06Q 40/08

(52) U.S. Cl. CPC G06Q 50/163; G06Q 10/20; G06Q 40/08

(57) ABSTRACT

Apparatus and methods to expedite and facilitate data communications are disclosed. In some examples, a plurality of mobile devices are in communication with a server. Each of the plurality of mobile devices may execute an application that allows for the submission of information related to damaged property. For example, the executed application may allow for the selection of a type of damage, such as roof, window, or flooding damage, and based on the selection, may allow for the submission of additional information, such as attributes of the type of damaged property, and an estimated cost to repair or replace the damaged property. The plurality of mobile devices may then transmit the information to the server. The server may determine a claim amount based on the received information, and may generate and transmit a claim request for the claim amount.

### CROSS-REFERENCE TO RELATED APPLICATIONS

This application claims the benefit of priority to U.S. Provisional Pat. Application No. 63/331,036, filed on Apr. 14, 2022 and entitled “APPARATUS AND METHODS FOR DATA COMMUNICATION AMONG NETWORKED DEVICES,” the entire disclosure of which is expressly incorporated herein by reference to its entirety.

### FIELD OF THE INVENTION

The disclosures are related to data processing systems and, more specifically, to applications executed by networked devices to facilitate and expedite data communications.

### BACKGROUND

Often times companies must obtain information in their ordinary course of business. For example, insurers may need to visit an insured property, such as a house, car, boat, or any other insured property, to obtain information for a claim. Conventional methods of collecting the information may include filling out a form about the property, and then considering the information at a later time to evaluate and process the claim. Although some data processing systems allow for the electronic exchange of some information, they suffer from various deficiencies including a failure to include all required parties, a failure to collect all needed or beneficial information, and delayed response times, among other deficiencies.

### SUMMARY

In some examples, a computing device includes at least one processor. The at least one process is configured to receive input data, and determine a type of damage based on the input data. The at least one processor is also configured to provide for display a plurality of options based on the type of damage. Further, the at least one processor is configured to receive additional input data characterizing at least one selection of the plurality of options. The at least one processor is also configured to generate a message based on the input data and the additional input data. The at least one processor is further configured to transmit the message, such as to another computing device for processing.

In other examples, a method by at least one processor includes receiving input data, and determining a type of damage based on the input data. The method also includes providing for display a plurality of options based on the type of damage. Further, the method includes receiving additional input data characterizing at least one selection of the plurality of options. The method also includes generating a message based on the input data and the additional input data. The method further includes transmitting the message, such as to another computing device for processing.

In yet other examples, a tangible, non-transitory computer-readable medium stores instructions that, when executed by at least one processor, causes the at least one processor to perform operations. The operations include receiving input data, and determining a type of damage based on the input data. The operations also include providing for display a plurality of options based on the type of damage. Further, the operations include receiving additional input data characterizing at least one selection of the plurality of options. The operations also include generating a message based on the input data and the additional input data. The operations further include transmitting the message, such as to another computing device for processing.

Additionally, in some examples, a computing device includes at least one processor and is communicatively coupled to a database. The at least one processor is configured to receive data characterizing damage to a property, and determine, based on the data, that additional data is needed to generate a digital contract. The at least one processor is also configured to receive the additional data, and to generate the digital contract based on the data and the additional data. Further, the at least one processor is configured to transmit the digital contract. The at least one processor is also configured to receive an indication of whether the digital contract was digitally signed. The at least one processor is further configured to adjust a claim status value within the database based on the indication.

In other examples, a method by at least one processor includes receiving data characterizing damage to a property, and determining, based on the data, that additional data is needed to generate a digital contract. The method also includes receiving the additional data, and generating the digital contract based on the data and the additional data. Further, the method includes transmitting the digital contract. The method also includes receiving an indication of whether the digital contract was digitally signed. The method further includes adjusting a claim status value within the database based on the indication.

In yet other examples, a tangible, non-transitory computer-readable medium stores instructions that, when executed by at least one processor, causes the at least one processor to perform operations. The operations include receiving data characterizing damage to a property, and determining, based on the data, that additional data is needed to generate a digital contract. The operations also include receiving the additional data, and generating the digital contract based on the data and the additional data. Further, the operations include transmitting the digital contract. The operations also include receiving an indication of whether the digital contract was digitally signed. The operations further include adjusting a claim status value within the database based on the indication.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 illustrates an insurance data processing system in accordance with some embodiments;

FIG. 2 illustrates an exemplary computing device in accordance with some embodiments;

FIGS. 3 and 4 illustrates exemplary portions of the insurance data processing system of FIG. 1 in accordance with some embodiments;

FIG. 5 illustrates an exemplary computer-implemented method in accordance with some embodiments;

FIG. 6 illustrates another example exemplary computer-implemented method in accordance with some embodiments;

FIGS. 7A, 7B, 7C, 7D, 7E, 7F, 7G, 7H, 7I, 7J, 7K, 7L, 7M, 7N, 7O, 7P, 7Q, 7R, 7S, 7T, 7U, 7V, 7W, and 7X illustrate portions of an exemplary application interface in accordance with some embodiments; and

FIGS. 8A, 8B, 8C, 8D, 8E, 8F, 8G, and 8H illustrate exemplary dashboard interfaces in accordance with some embodiments.

### DETAILED DESCRIPTION

The description of the preferred embodiments is intended to be read in connection with the accompanying drawings, which are to be considered part of the entire written description of these disclosures. It should be understood, however, that the present disclosure is not intended to be limited to the particular forms disclosed. Rather, the present disclosure covers all modifications, equivalents, and alternatives that fall within the spirit and scope of these exemplary embodiments.

In this description, terms such as “couple,” “coupled,” “operatively coupled,” “operatively connected,” “communicatively coupled” and the like should be broadly understood to refer to devices or components connected together either mechanically, electrically (e.g., wired, wirelessly), or otherwise, such that the connection allows the pertinent devices or components to operate (e.g., communicate) with each other as intended by virtue of that relationship.

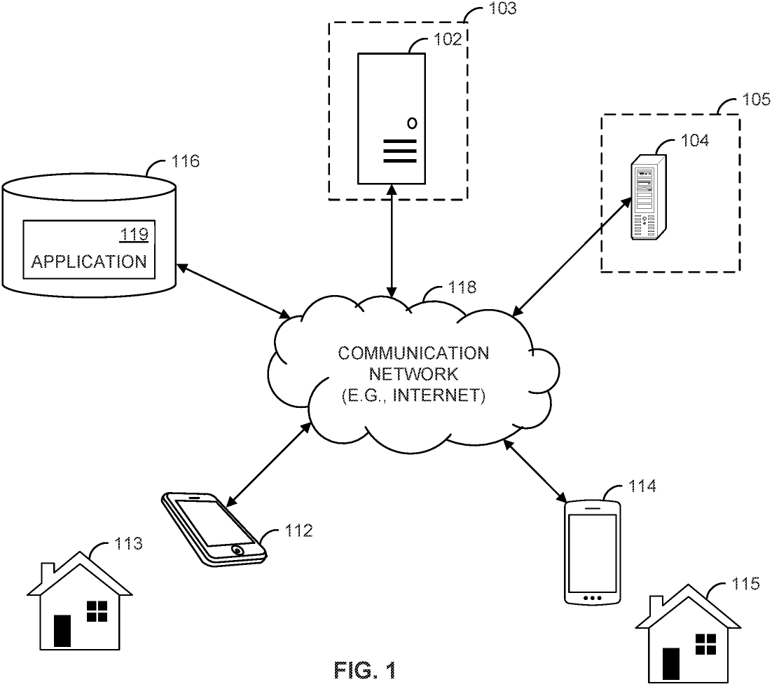

Turning to the drawings, FIG. 1 shows a block diagram of an insurance data processing system 100 that includes an insurance adjusting (IA) computing device 102, an insurer computing device 104, one or more contractor computing devices 112, 114, and a database 116 communicatively coupled to communication network 118. IA computing device 102 may be operated by an insurance adjusting company 103, while insurer computing device 104 may be operated by an insurance company, for example. Further, contractor computing devices 112, 114 may be operated by contractors, such as roofing or window replacement professionals, for example.

Each of IA computing device 102, insurer computing device 104, and contractor computing devices 112, 114 may include hardware or hardware and software for processing data, such as image data or audio data. For example, each may include one or more processors, one or more field-programmable gate arrays (FPGAs), one or more application-specific integrated circuits (ASICs), one or more state machines, digital circuitry, or any other suitable circuitry. In some examples, each of IA computing device 102, insurer computing device 104, and contractor computing devices 112, 114 may be an application server, a cloud-based server, a computer, a workstation, a laptop, a tablet, a mobile device such as a cellular phone or smart phone, or any other suitable computing device.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Database 116 can be any suitable non-volatile memory, such as a remote storage device, a memory device of a cloud-based server, a memory device on another application server, a memory device of a networked computer, or any other suitable non-transitory data storage device. In some examples, database 116 can be a local storage device, such as a hard drive, a non-volatile memory, or a USB stick. In some examples, database 116 stores applications, such as application 119. For example, database 116 may support an application store (“App store”) that allows for the download of application 119, among other applications.

Contractor computing devices 112, 114 may be configured to download one or more applications, such as application 119, from database 116, and to execute the downloaded application. As described herein, the executed application 119 may facilitate the capture and display of information, such as insurance information. For example, the executed application 119 may cause contractor computing devices 112, 114 to display one or more user interfaces that, based on user (e.g., contractor) input, capture information related to damage to one or more properties 113, 115. The information may include, for example, customer information (e.g., name, address, phone number, email address, etc. of an owner of properties 113, 115), damage information (e.g., type of damaged structure, such as roof or window damage, properties or attributes of damaged structure (e.g., type of structure, material structure is made from, date structure was installed, age of structure, etc.), estimated repair or replacement costs, etc.), insurance information (e.g., insurer, still images and video of damaged structure, insurance contract, property blueprints, etc.), or any other suitable information as described herein.

Further, the executed application 119 may cause contractor computing devices 112, 114 to transmit the captured information (e.g., in accordance with one or more protocols) to IA computing device 102. For example, IA computing device 102 may support one or more application programming interface (API) endpoints that allow for the reception of information, such as the information described above. In some examples, the executed application 119 may cause contractor computing devices 112, 114 to “push” the information to the one or more endpoints over communication network 118. In some examples, IA computing device 102 requests the information from the contractor computing devices 112, 114 for one or more of the endpoints (e.g., an API “pull” mechanism).

Based on at least portions of the received information, IA computing device 102 may automatically generate a digital contract between insurance adjusting company 103 and an owner of the corresponding property 113, 115. For example, IA computing device 102 may parse the received information to extract one or more of the customer information, damage information, and insurance information, and may populate a digital contract with the extracted information. In some examples, IA computing device 102 may determine that additional information is required before the digital contact is generated. In response, IA computing device 102 may generate a message characterizing the additional information needed (e.g., additional pictures, insurance information, etc.), and may transmit the message to a contractor computing device 112, 114, which may cause the receiving contractor computing device 112, 114 to populate at least portions of a user interface of the executed application 119 with data characterizing the additional information needed. The contractor may provide input to the executed application 119 characterizing the additional information, and the contractor computing device 112, 114 may generate a response message that includes data characterizing at least portions of the additional information. The contractor computing device 112, 114 may transmit the response message to IA computing device 102. Based on the received response message, IA computing device 102 may generate the digital contract.

IA computing device 102 may transmit the digital contract to the customer for approval and signature. For example, IA computing device 102 may generate and transmit an email to an email address of the customer. In some examples, the email includes a link to a web address (e.g., a portal) hosted or managed by IA computing device 102 that displays the digital contract (e.g., stored in database 116). The customer may view and click the link on a device (e.g., a computer or mobile device), causing a browser of the customer’s device to display the digital contract. The customer may digitally sign the digital contract, which may then be stored in database 116. In some examples, the email may include the digital contact as an attachment. Upon opening and signing the digital contract, the contractor computing device 112, 114 may transmit the signed contract to IA computing device 102. Further, once the digital contract is signed, IA computing device 102 may generate a message characterizing the digital contract as signed, and may transmit the message to one or more of the customer’s device and contractor computing devices 112, 114.

Further, in some examples, IA computing device 102 may automatically generate a digital proposal that characterizes a claim for the damage to the corresponding property 113, 115, as well a claim amount. In some examples, IA computing device 102 generates the digital proposal after review and consideration by insurance adjusting company 103. For instance, one or more associates of insurance adjusting company 103 may review the received customer information, damage information, and insurance information, and may determine whether to accept the digital proposal. If accepted, IA computing device 102 generates the digital proposal. Further, IA computing device 102 transmits the digital proposal to insurer computing device 104, which may be operated by the customer’s insurer 105. The digital proposal may also allow for an acceptance, such as by allowing for a digital signature of insurer 105. For example, IA computing device 102 may generate and transmit an email to an email address of the insurer 105. In some examples, the email includes a link to a web address (e.g., a portal) hosted or managed by IA computing device 102 that displays the digital proposal (e.g., stored in database 116). The insurer 105 may view and click the link (e.g., as displayed by insurer computing device 104), causing a browser of insurer computing device 104 to display the digital proposal. In some examples, the email may include the digital proposal as an attachment. Upon the digital proposal being signed, IA computing device 102 may generate a message indicating that the claim has been accepted, and may transmit the message to one or more of the customer’s device and contractor computing devices 112, 114. The repairs may then be made to the corresponding property 113, 115 by the corresponding contractors.

In some examples, IA computing device 102 determines the claim amount based on any estimated repair or replacement costs received from contractor computing devices 112, 114. For example, IA computing device 102 may determine a percentage of the estimated repair or replacement costs, and may add the percentage of the estimated repair or replacement costs to the estimated repair or replacement costs to determine the claim amount. The percentage may be a set fee based on the type of damage (e.g., water damage, wind damage, fire damage, etc.), regardless of the estimated repair or replacement costs. In some examples, IA computing device 102 determines the claim amount based on a predetermined fee amount (e.g., $5,000) and the estimated repair or replacement cost. For example, IA computing device 102 may add the predetermined fee amount to the estimated repair or replacement cost to determine the claim amount. In other examples, IA computing device 102 generates features based on one or more of the received information, such as the estimated repair or replacement costs, and applies a trained machine learning model to the generated features to determine the claim amount. In some examples, the machine learning model is trained based on features generated from previous claims. The previous claims may include one or more of geographical data (e.g., zip codes, cities, addresses, etc.), damage information, insurance information, and claim amounts, for example.

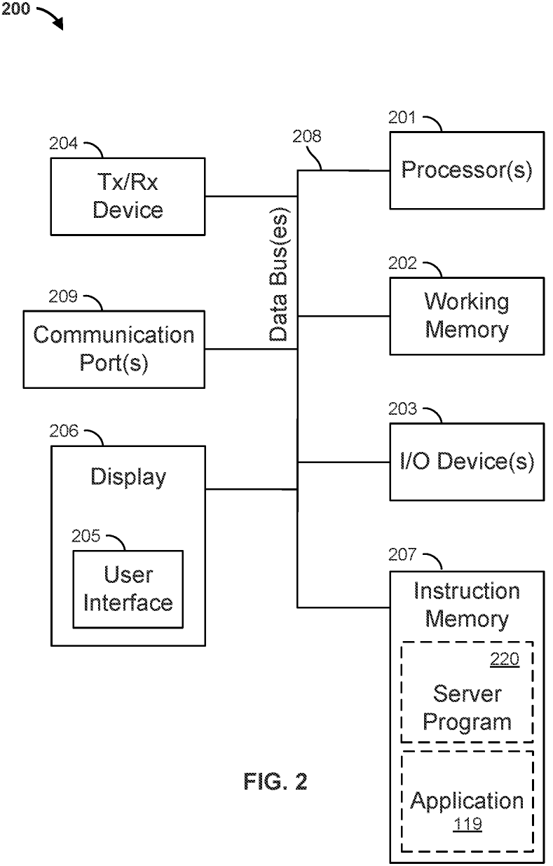

FIG. 2 illustrates an exemplary computing device 200. Computing device 200 may be an example of IA computing device 102, or one of contractor computing devices 112, 114, for example. As illustrated in FIG. 2, computing device 200 may include one or more processors 201, a working memory 202, one or more input/output devices 203, an instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processor(s) 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can be configured to perform a certain function or operation by executing code, stored on instruction memory 207, embodying the function or operation. For example, processors 201 can be configured to perform one or more of any function, method, or operation disclosed herein, such as generating and transmitting digital contracts and proposals as described herein. Processors 201 may obtain executable instructions from instruction memory 207, and may execute the instructions to perform the functions described herein. For instance, in an embodiment where computing device 200 is an example of IA computing device 102, computing device 200 may obtain server program 220 from instruction memory 207, and may execute server program 220 to perform any corresponding functions. In an embodiment where computing device 200 is an example of one of contractor computing devices 112, 114, computing device 200 may obtain application 119 from instruction memory 207, and may execute application 119 to perform any corresponding functions.

Further, processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of computing device 200. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in instruction memory 207. In some examples, the communication port(s) 209 allow for the transfer (e.g., uploading or downloading) of data, such as claim information data.

Display 206 can be any suitable display, such as a micro-LED display, and can display user interface 205. User interface 205 can enable user interaction with computing device 200. For example, user interface 205 can be a user interface for application 119. In some examples, a user can interact with user interface 205 by engaging input-output devices 203.

Transceiver 204 may be any suitable communication unit that allows for communication with a network, such as communication network 118 of FIG. 1. In some examples, transceiver 204 is selected based on the type of communication network 118 computing device 200 will be operating in. For example, if communication network 118 of FIG. 1 is a WiFi® network, transceiver 204 is configured to allow communications with the WiFi® network. Processor(s) 201 is operable to receive data from, or send data to, a network, such as communication network 118 of FIG. 1, via transceiver 204.

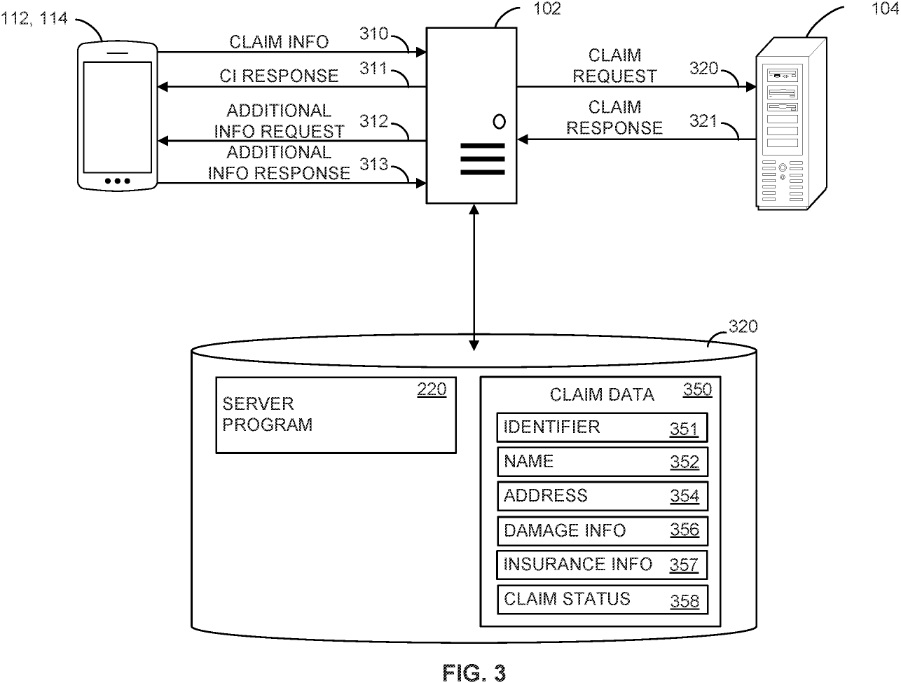

FIG. 3 is a block diagram illustrating exemplary portions of the insurance data processing system 100 of FIG. 1. As indicated in the figure, database 330 may store server program 220 and claim data 350. Server program 220 may include executable instructions that, when executed by one or more processors of IA computing device 102, cause IA computing device 102 to perform corresponding functions. For example, the executed server program 220 may cause of IA computing device 102 to implement an API for communications with contractor computing device 112, 114. Further, and as described herein, the executed server program 220 may cause of IA computing device 102 to host a web-based application, such as a portal, that can receive information from users, and provide information for display. For example, the web-based application may display information for each of a plurality of insurance claims.

Referring back to FIG. 3, contractor computing device 112, 114 can generate a claim information message 310, which may identify a referral from a contractor to insurance adjusting company 103. The claim information message 310 may identify and characterize, for example, one or more of customer information (e.g., name, address, phone number, email address, etc. of an owner of properties 113, 115), damage information (e.g., type of damaged structure, such as roof or window damage, properties or attributes of damaged structure (e.g., type of structure, material structure is made from, date structure was installed, age of structure, etc.), estimated repair or replacement costs, etc.), insurance information (e.g., insurer, still images and video of damaged structure, insurance contract, property blueprints, etc.), or any other suitable information as described herein. For instance, a contractor, such as a roofer, may visit a property 113, 115 that has been damaged by a storm (e.g., hail, tornado, hurricane, thunderstorm, fire, etc.). The contractor may obtain customer information from the owner of the property 113, 115, and may assess the property 113, 115 to determine at least portions of the damage information. Further, the contractor may input the information into a user interface displayed by the contractor computing device 112, 114, such as one displayed by executed application 119. In some examples, the contractor may take pictures or video of the property 113, 115 with the contractor computing device 112, 114 (e.g., with one or more cameras of contractor computing device 112, 114). The executed application 119 may include functionality to allow the contractor to append the pictures and video to the insurance information. For example, the executed application 119 may include an “UPLOAD” icon that, when engaged by the contractor, allows the contractor to submit the pictures and video to the executed application 119.

The contractor computing device 112, 114 may include at least portions of the inputted information, such as the customer information, damage information, and insurance information, into claim information message 310. In some examples, a first claim information message 310 includes the customer information, while a second claim information message 310 includes claim scope information (e.g., damage information). For instance, the contractor may provide the customer information to the executed application 119 on a first day, and contractor computing device 112, 114 may transmit the first claim information message 310 that includes the customer information to IA computing device 102 on the first day. The contractor may come back to the property 113, 115 to assess the damage on a second day (e.g., a day after the first day, three days after the first day, a week after the first day, etc.), and may provide the damage information to the executed application 119. Contractor computing device 112, 114 may transmit the second claim information message 310 that includes the damage information to IA computing device 102 on the second day.

In some examples, the executed application 119 adds a claim identifier to the claim information message 310. The claim identifier may be a value that identifies a corresponding claim. In some examples, the executed application 119 generates a random number between a minimum value (e.g., 0) and a maximum value (e.g., 0xFFFF_FFFF) to use as the claim identifier. In some examples, the claim identifier is generated based on a time corresponding to when the information is inputted by the contractor (e.g., the time of the last entry). The contractor computing device 112, 114 may transmit the claim information message 310 to IA computing device 102. For example, contracting computing device 112, 114 may push the claim information message 310 to the API supported by the executed server program 220.

In response to receiving claim information message 310, IA computing device 102 may generate a claim information response message 311 acknowledging the reception of claim information message 310 (e.g., the referral). The claim information response message 311 may include, in some examples, the claim identifier received in the claim information message 310. IA computing device 102 may parse the claim information message 310 to extract the information, such as any customer information, damage information, insurance information, and claim identifier, and may store the extracted portions with a claim data 350 portion of database 320. For example, claim data 350 may include, among other data, a claim identifier 351, a name 352 of the customer, an address 354 of the corresponding property 113, 115, damage information 356, and insurance information 357. In some examples, claim data 350 further includes a claim status 358. For example, and upon receiving a claim information message 310, IA computing device 102 may initialize the claim status 358 to a value (e.g., 0×01) that indicates “RECEIVED.” Once the claim is accepted by insurance adjusting company 103, IA computing device 102 may adjust the claim status 358 to another value (e.g., 0×02) that indicates “OPENED.”

In some examples, IA computing device 102 may determine that claim information message 310 fails to include information, such as information required to generate a digital contract or digital proposal. For example, claim information message 310 may determine that the claim information message 310 fails to include at least portions of any of insurance information, damage information, or customer information. Based upon the determination, IA computing device 102 may generate an additional information request message 312 that identifies and characterizes the missing information. For example, the additional information request message 312 may include fields associated with each possible missing information, where each field may include a value characterizing whether or not the corresponding information is missing (e.g., 0×00 may indicate the information corresponding to a field was received, and 0×10 may indicate the information corresponding to a field is missing). IA computing device 102 may transmit the additional information request message 312 to contractor computing device 112, 114.

In response to receiving an additional information request message 312, the executed application 119 may perform operations to determine which information is requested (e.g., based on the values within the fields associated with missing information), and may cause the display of a user interface that indicates the missing information. For example, the executed application 119 may associate the fields indicating missing information with predetermined text (e.g., “insurance policy number is missing,” “estimated damage amount is missing,” etc.), and may display the predetermined text within the user interface. In response, the contractor may provide the missing information by providing input to the contractor computing device 112, 114, and the executed application 119 may generate an additional information response message 313 that identifies and characterizes the missing information.

In some examples, the missing information is added to corresponding fields (e.g., missing information fields) of the additional information response message 313. In some examples, the missing information is appended with a field ID that corresponds to the field received in the additional information request message 312 indicating that information was missing. Contractor computing device 112, 114 transmits the additional information response message 313 to IA computing device 102. In response to receiving the additional information response message 313, IA computing device 102 parses and extracts the additional information from the additional information response message 313, and stores the extracted information into the corresponding portion of claim data 350 within database 116.

Further, and based on the received information and, in some examples, the received additional information, the executed server program 220 may generate a digital proposal characterizing a claim for the damage to the corresponding property 113, 115. The digital proposal may include, for example, an address 354 of the property 113, 115, a name 352 of the customer, at least portions of the damage information 356, at least portions of insurance information 357, and a claim amount. As described herein, the executed server program 220 may determine the claim amount based on an estimated repair or replacement costs. In some examples, the executed server program 220 generates features based on portions of the received information, such as address 354, the estimated repair or replacement costs, and the type of damaged structure, and applies a trained machine learning model to the generated features to determine the claim amount. In some examples, the machine learning model is trained based on features generated from previous claims. The previous claims may include one or more of geographical data (e.g., zip codes, cities, addresses, etc.), damage information, insurance information, and claim amounts, for example. The digital proposal may also allow for a digital signature of insurer 105. The executed server program 220 may package the digital proposal within a claim request message 320, and may transmit the claim request message 320 to the corresponding insurer computing device 104 of the insurer 105. Further, the executed server program 220 may adjust the corresponding claim status 358 to “SUBMITTED” (e.g., 0×03).

In response to receiving the claim request message 320, insurer computing device 104 may display the digital proposal to the insurer 105. In some examples, the insurer 105 may decide to not sign the digital proposal. If so, insurer computing device 104 may generate a claim response message 321 indicating that the claim has been denied. If, however, the insurer 105 signs the digital proposal (e.g., accepting the digital proposal), insurer computing device 104 may generate a claim response message 321 indicating that the claim has been accepted. Insurer computing device 104 may transmit the claim response message 321 to IA computing device 102. Based on the received claim response message 321, the executed server program 220 of IA computing device 102 may adjust the corresponding claim status 358. For example, if the claim response message 321 indicates that the claim was denied, the executed server program 220 may adjust the claim status 358 to “DENIED” (e.g., 0×20). If the claim response message 321 indicates that the claim was accepted, the executed server program 220 may adjust the claim status 358 to “ACCEPTED” (e.g., 0×20).

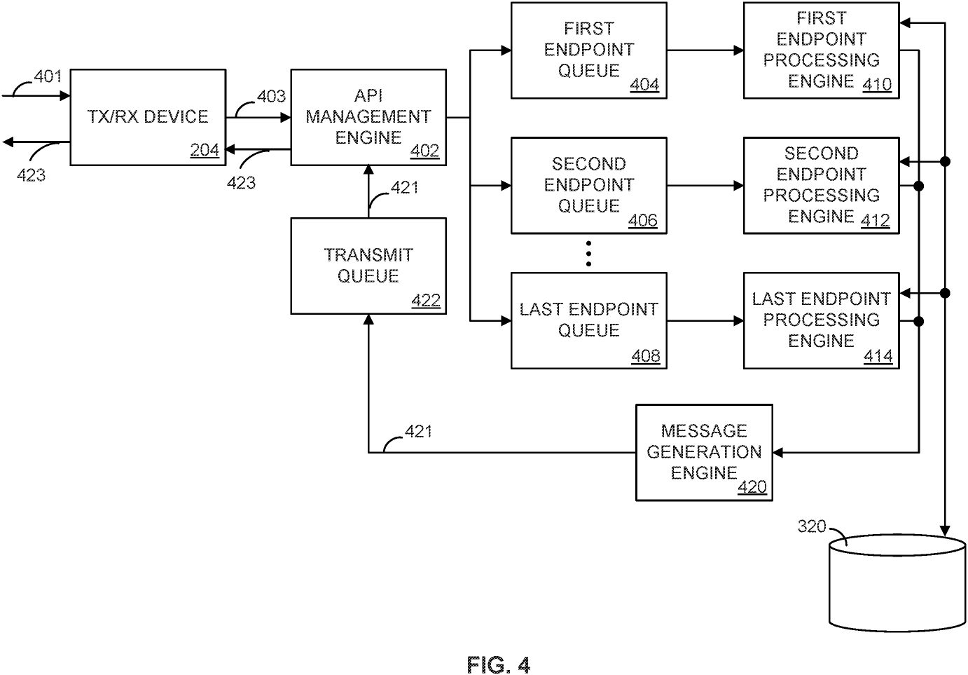

FIG. 4 is a block diagram illustrating, among other things, further details of the IA computing device 102 of FIG. 1. As illustrated, IA computing device 102 includes API management engine 402, first endpoint processing engine 410, second endpoint processing engine 412, last endpoint processing engine 414, and message generation engine 420. In some examples, each of API management engine 402, first endpoint processing engine 410, second endpoint processing engine 412, last endpoint processing engine 414, and message generation engine 420 are implemented in hardware. In some examples, each of API management engine 402, first endpoint processing engine 410, second endpoint processing engine 412, last endpoint processing engine 414, and message generation engine 420 are implemented by the execution of instructions by one or more processors, such as by processor 201 executing instructions stored in instruction memory 207.

API management engine 402 manages the reception, and transmission, of data based on corresponding API endpoints. API management engine 40 may be configured to receive data from transceiver 204. For example, transceiver 204 may receive input data 401, such as a claim information message 310 or additional information response message 313, and may package the data into one or more data packets 403. API management engine 402 may receive the data packets 403 from transceiver 204, and may determine a corresponding endpoint for the data packets 403. For example, API management engine 402 may parse a data packet 403 in accordance with a protocol, such as the TCP/IP protocol, to determine the API endpoint (e.g., TCP endpoint) for the data packet.

In this example, API management engine 402 may determine the endpoint for a data packet 403, and may route the data packet to a queue based on the determined endpoint. For example, API management engine 402 may route the data packets 403 to a first endpoint queue 404 corresponding to a first endpoint, to a second endpoint queue 406 corresponding to a second endpoint, and to a last endpoint queue 408 corresponding to a last endpoint. Although three endpoint queues are illustrated, IA computing device 102 can support any suitable number of endpoints. Each of the first endpoint queue 404, second endpoint queue 406, and last endpoint queue 408 may be memory storage areas (e.g., within working memory 202) where the data packets 403 can be stored.

Further, first endpoint processing engine 410 is configured to obtain (e.g., read) data packets 403 from first endpoint queue 404. Similarly, second endpoint processing engine 412 is configured to obtain data packets 403 from second endpoint 406, and last endpoint processing engine 414 is configured to obtain data packets 403 from last endpoint processing engine 414. In some examples, each of the first endpoint queue 404, second endpoint queue 406, and last endpoint queue 408 store at least portions of the obtained data packets 403 within database 320. For example, each of the first endpoint queue 404, second endpoint queue 406, and last endpoint queue 408 may parse the data packets 403 to obtain information, such as customer information, damage information, and insurance information, and can store the parsed information accordingly within claim data 350.

Each of first endpoint queue 404, second endpoint queue 406, and last endpoint queue 408 may perform operations to process the received data packets 403 according to functions associated with their corresponding endpoints. For example, the first endpoint may support the reception of claim information messages 310 and the transmission of claim information response messages 311. The second endpoint may support the transmission of additional information request messages 312 and the reception of additional information response messages 313. The last endpoint may support the transmission of claim requests message 320 and the reception of claim response messages 321. These are merely exemplary configurations and the endpoints can be configured to support the reception and/or transmission of any suitable data.

Additionally, each of the first endpoint queue 404, second endpoint queue 406, and last endpoint queue 408 may operate as first-in first-out (FIFO) memory storage areas, where the corresponding endpoint processing engine 410, 412, 414 reads the oldest data packet 403 from the queue before others. In some examples, the first endpoint queue 404, second endpoint queue 406, and last endpoint queue 408 periodically poll the corresponding queues 404, 406, 408 (e.g., every 10 µsecs, every 10 msecs, every second) to determine if they contain any data packets 403. In some examples, the first endpoint queue 404, second endpoint queue 406, and last endpoint queue 408 receive a signal, such as an interrupt, when a data packet 403 is stored to the corresponding queue 404, 406, 408.

Each of the first endpoint queue 404, second endpoint queue 406, and last endpoint queue 408 may perform operations in accordance with their corresponding endpoint. For example, first endpoint processing engine 410 may receive and process claim information messages 310 and, in response, generate data to be packaged within a claim information response message 311 (e.g., a claim identifier and an acknowledgement). First endpoint processing engine 410 may provide the data to message generation engine 420. Second endpoint processing engine 410 may generate data to be packaged within additional information request messages 312 when additional information is needed to generate a digital contract or digital proposal as described herein, for example, and may receive and process additional information response messages 313. Second endpoint processing engine 412 may provide the data to message generation engine 420. The last endpoint processing engine 414 can generate data to be packaged within claim request messages 320, such as a digital proposal, and may receive and process claim response messages 321. Second endpoint processing engine 412 may provide the data to message generation engine 420.

Message generation engine 420 may receive data from each of first endpoint processing engine 410, second endpoint processing engine 412, and last endpoint processing engine 414, and may generate a corresponding message 421 for transmission. For example, message generation engine 420 may package data received from first endpoint processing engine 410 within a claim information response message 311, and may provide (e.g., store) the claim information response message 311 to transmit queue 422. Similarly, message generation engine 420 may package data received from second endpoint processing engine 412 within an additional information request messages 312, and may provide the additional information request messages 312 to transmit queue 422. Message generation engine 420 may package data received from last endpoint processing engine 414 within a claim request message 320, and may provide the claim request message 320 to transmit queue 422.

API management engine 402 may obtain (e.g., read) messages 421 from transmit queue 422, and may parse the messages 421 to generate data packets 423 in accordance with a predefined protocol between transceiver 204 and API management engine 402. API management engine 402 may provide the data packets 423 to transceiver 204 for transmission. For example, API management engine 402 may periodically pool the transmission queue 422 to determine if any messages 421 are ready for transmission. If, when polled, any messages 421 are held in the transmission queue 422, API management engine 402 reads at least a minimum number of the messages 421, generates data packets 423 based on the obtained messages 421, and provides the data packets 423 to the transceiver 204 for transmission. In some examples, API management engine 402 receives a signal (e.g., interrupt) from the transmit queue 422 once a minimum number of messages (e.g., 1, 3, 5) 421 are stored and ready for transmission. Upon receiving the interrupt, API management engine 402 may obtain at least a minimum number of messages 421 from the transmission queue 422, generates data packets 423 based on the obtained messages 421, and provides the data packets 423 to the transceiver 204 for transmission (e.g., in accordance with the defined protocol between transceiver 204 and API management engine 402).

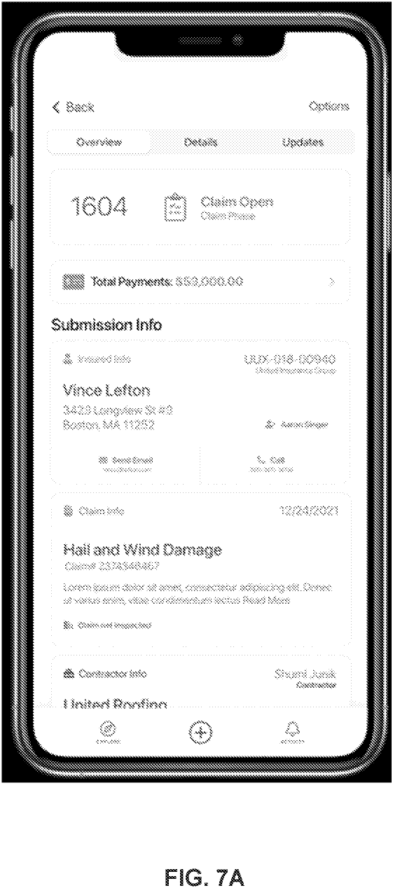

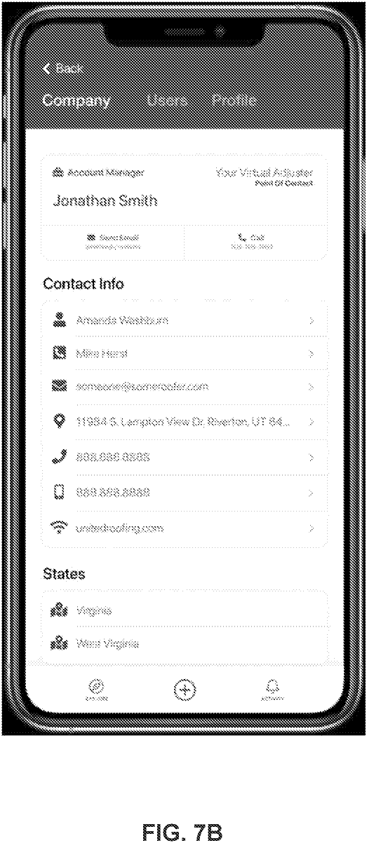

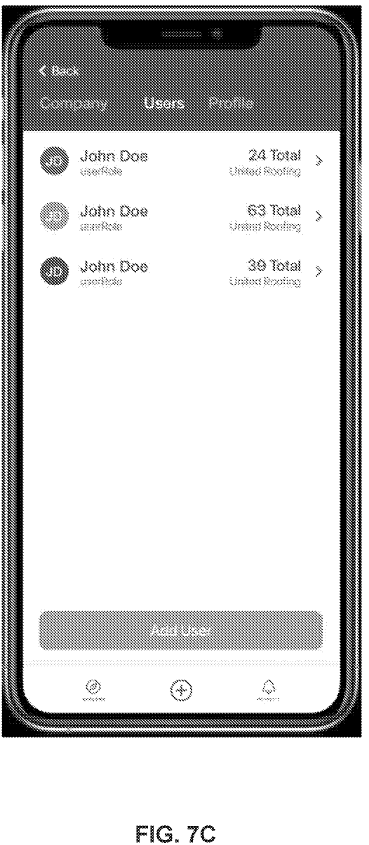

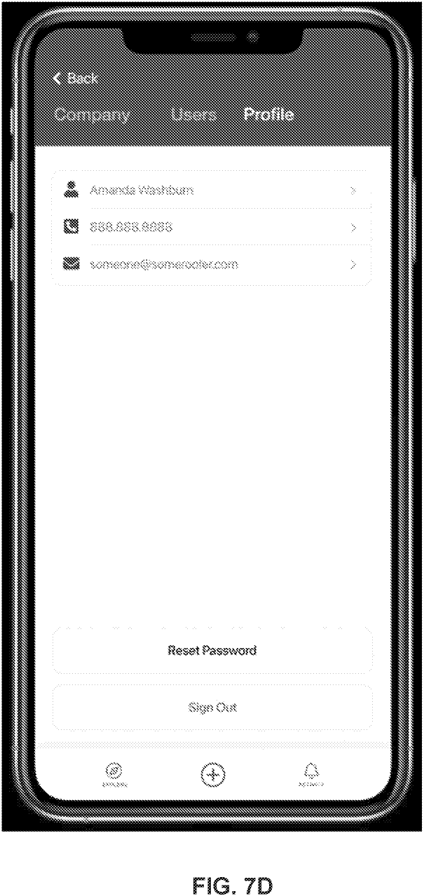

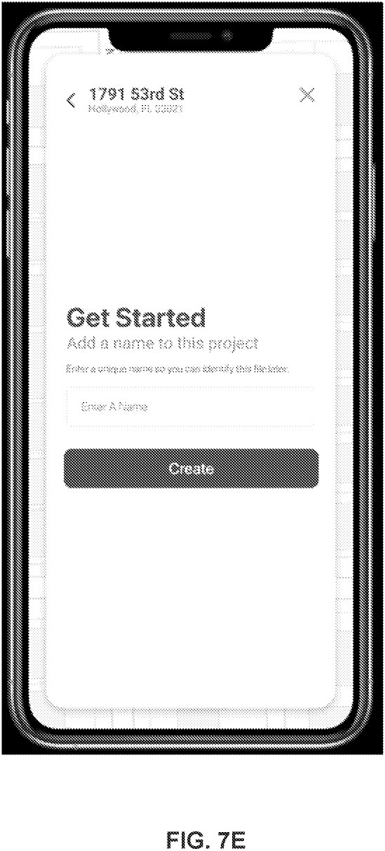

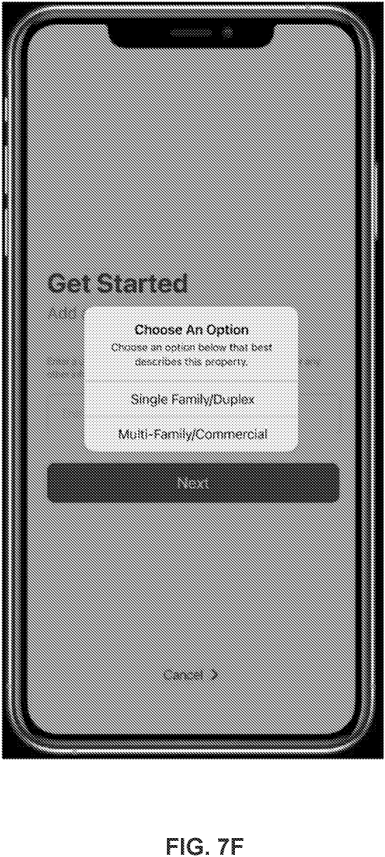

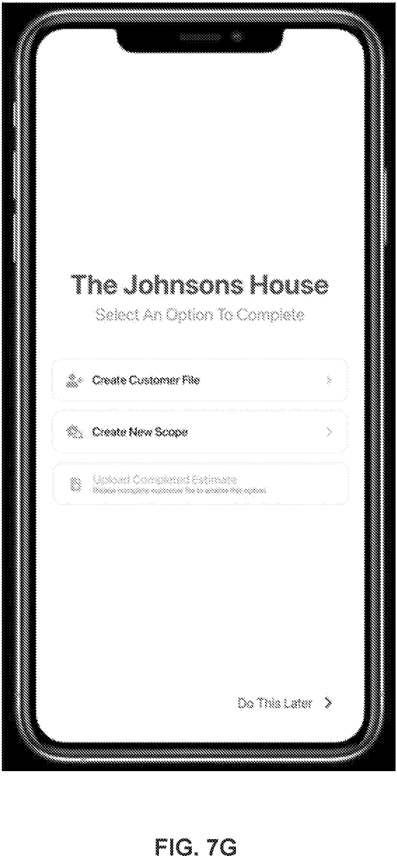

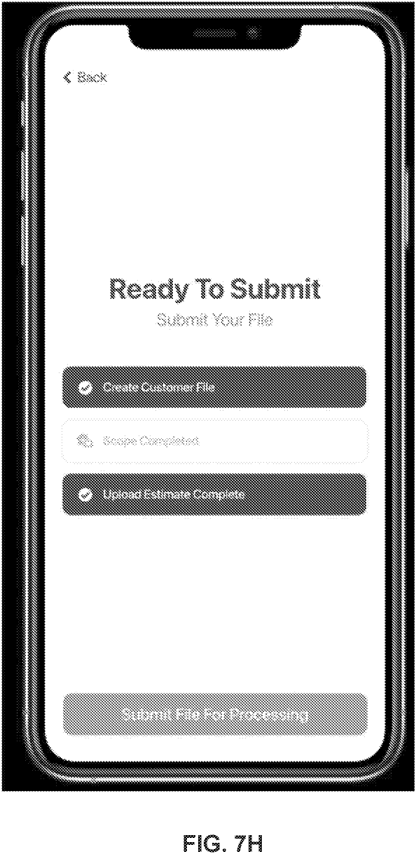

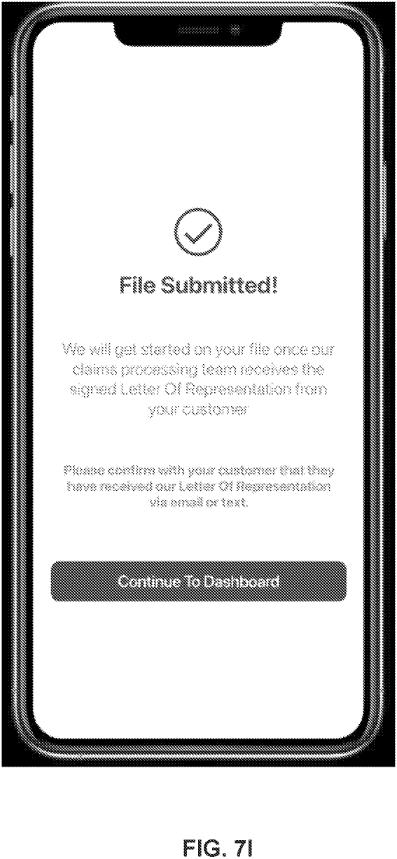

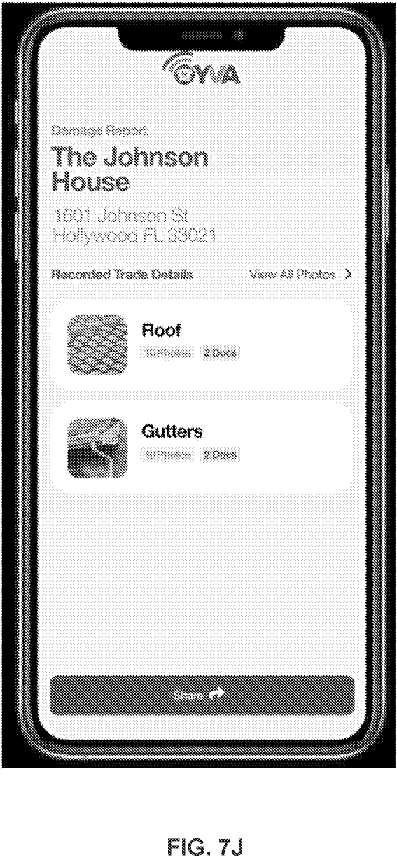

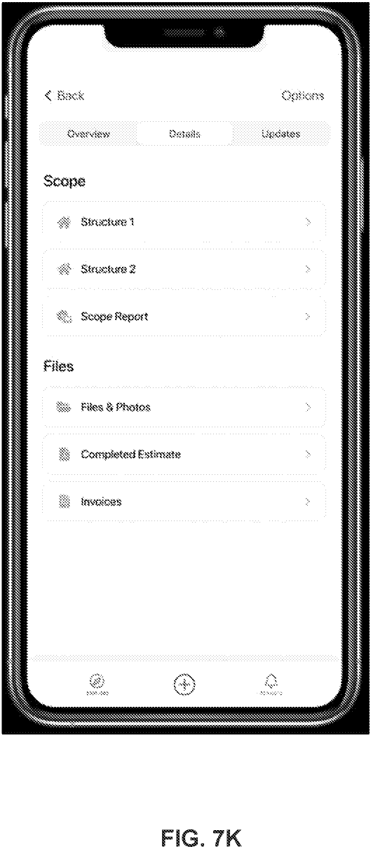

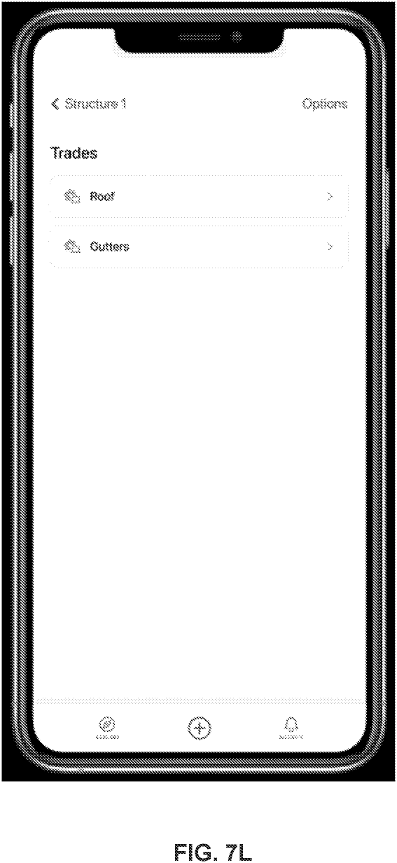

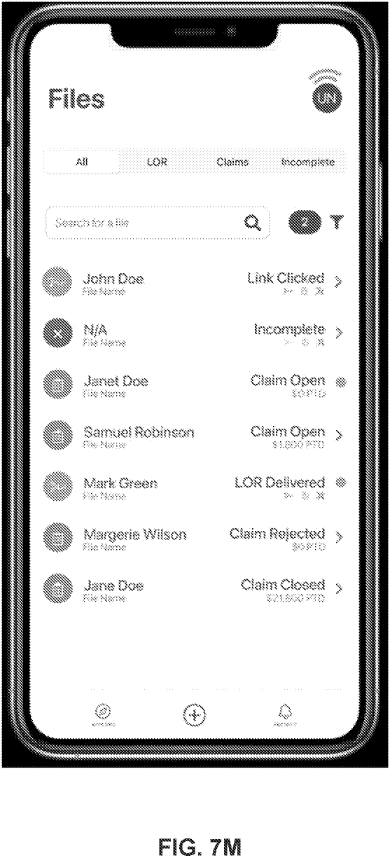

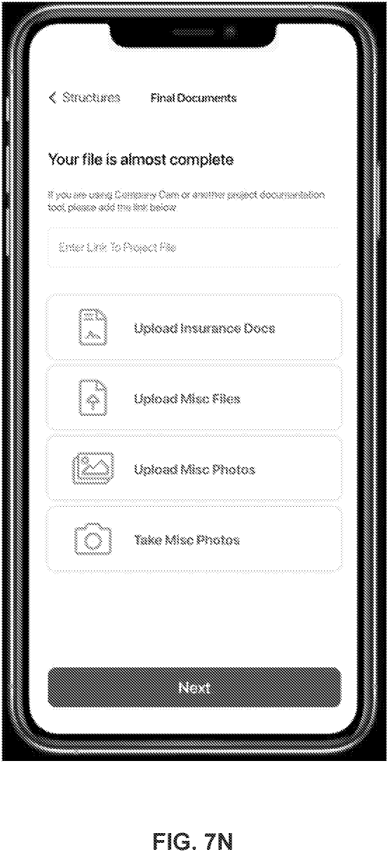

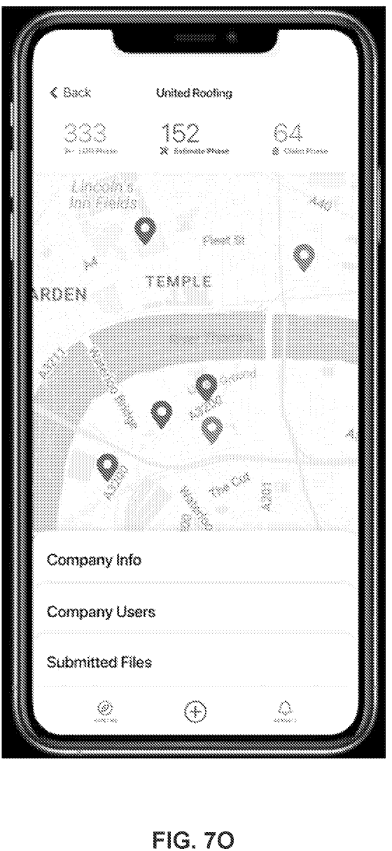

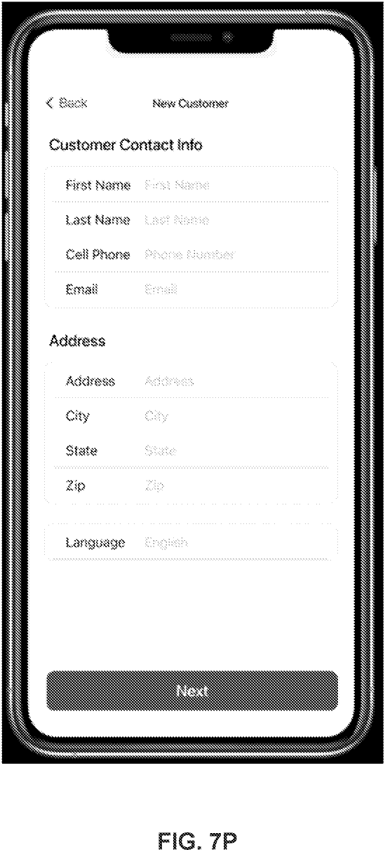

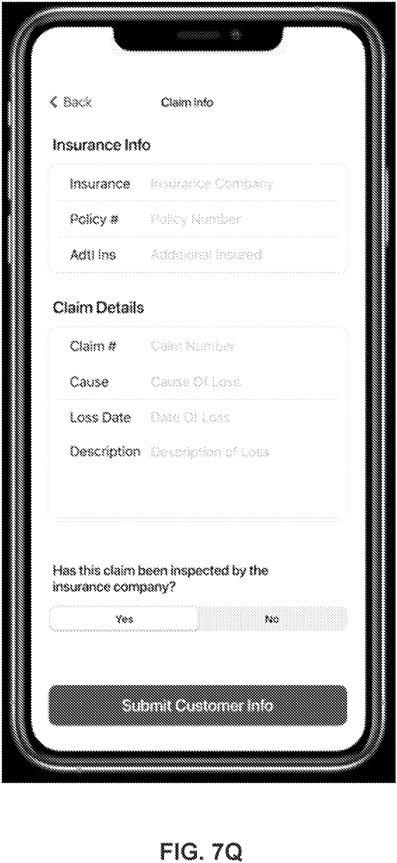

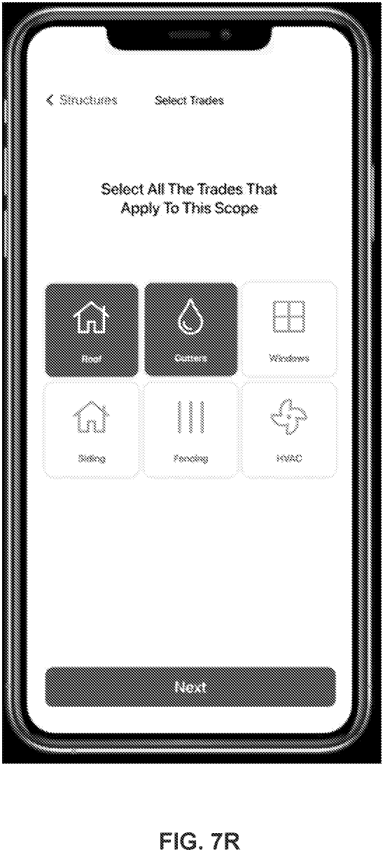

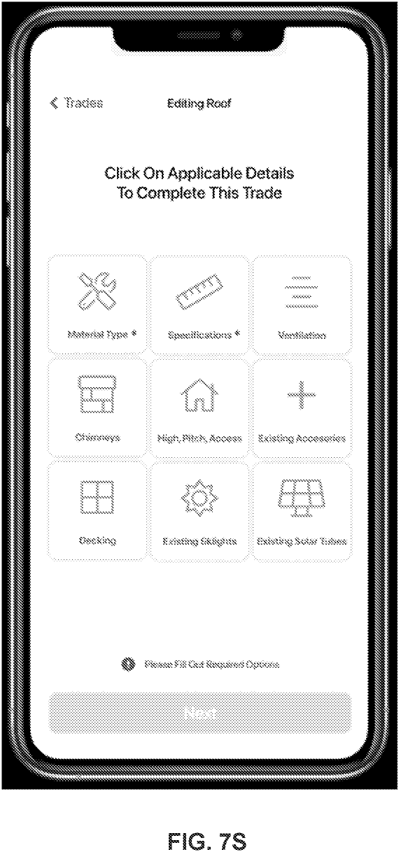

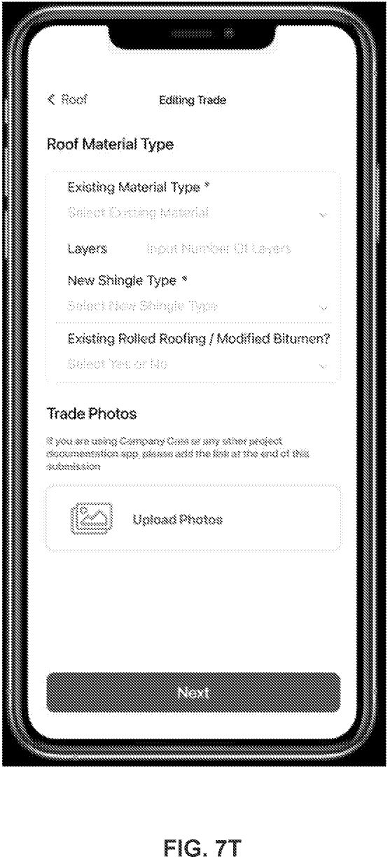

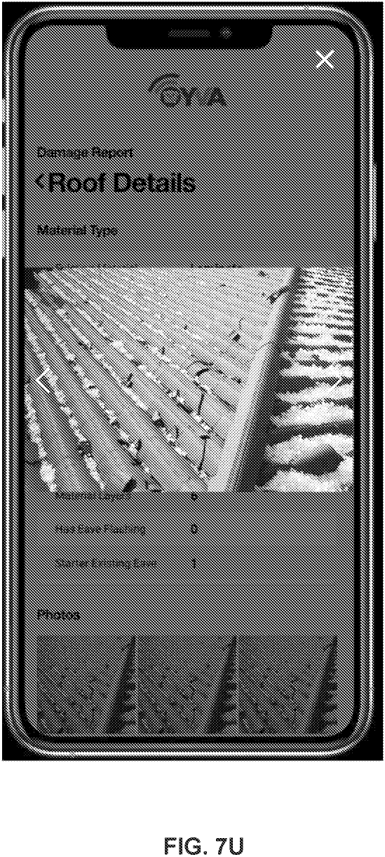

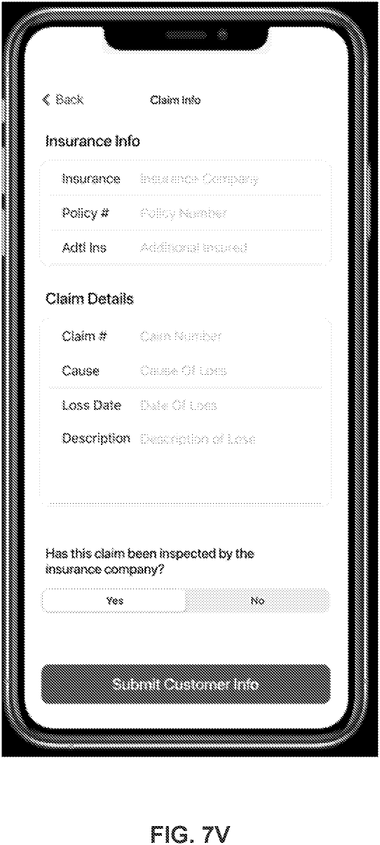

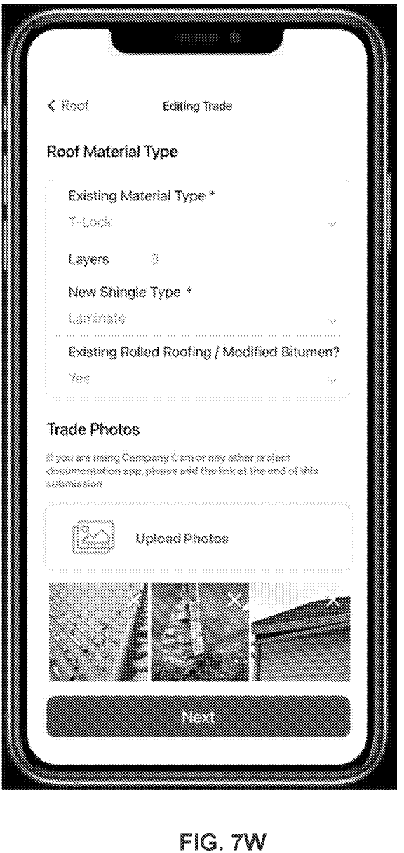

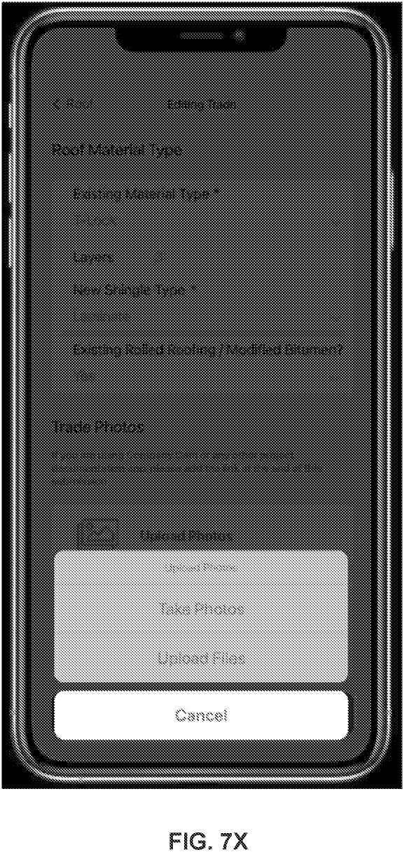

FIGS. 7A, 7B, 7C, 7D, 7E, 7F, 7G, 7H, 7I, 7J, 7K, 7L, 7M, 7N, 7O, 7P, 7Q, 7R, 7S, 7T, 7U, 7V, 7W, and 7X illustrate portions of an exemplary application interface that may be displayed, for example, by contractor computing device 112, 114. The executed application interface may, for example, allow for the input of information, such as customer information, insurance information, and damage information, including estimated repair and replacement cost information, as described herein, and may cause the contractor computing device 112, 114 to transmit at least portions of the information to IA computing device 102 (e.g., via claim information messages 310 and additional information response messages 313).

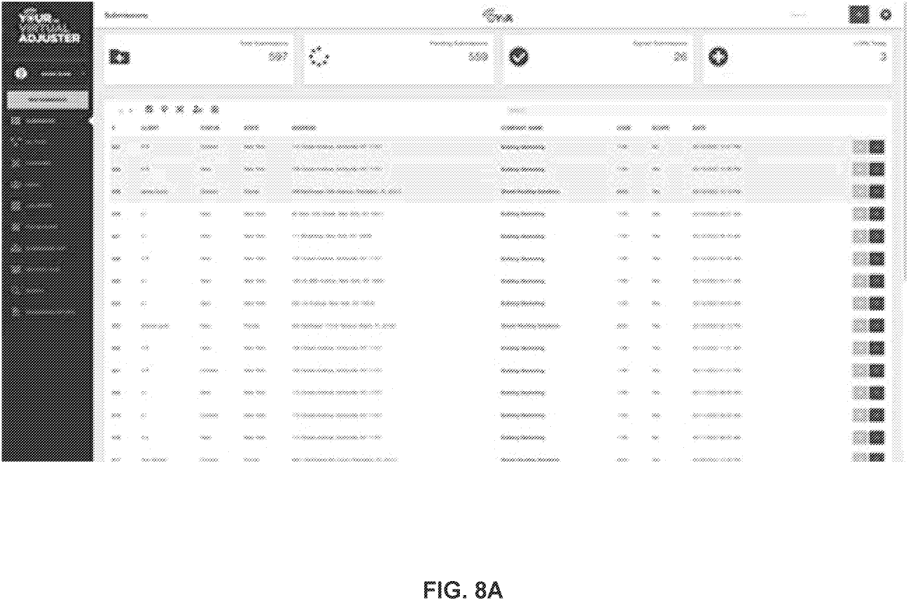

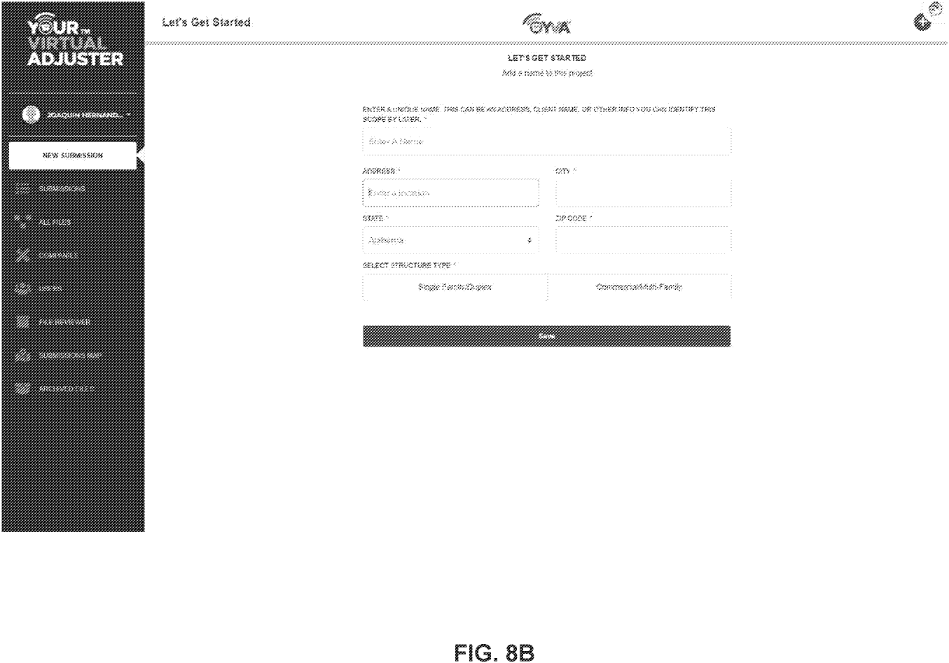

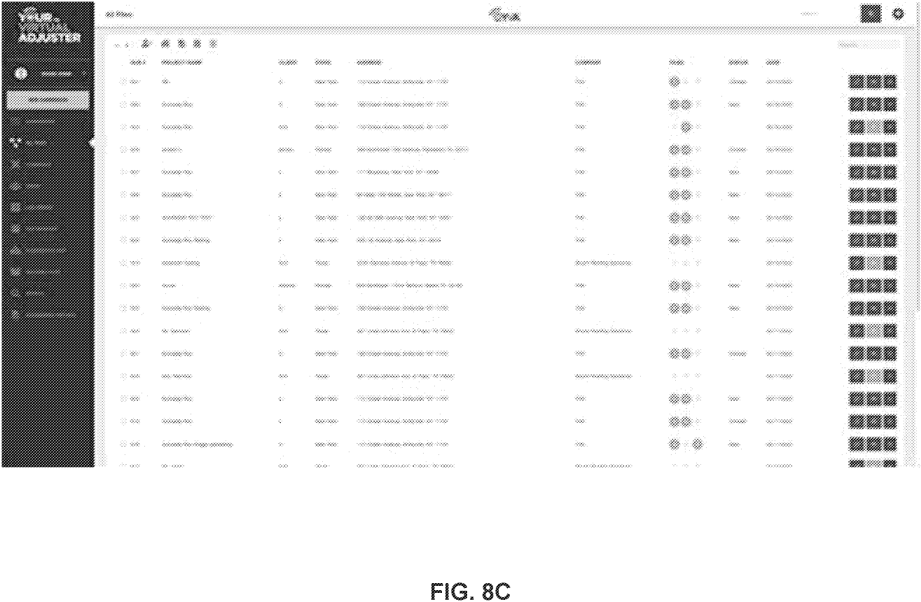

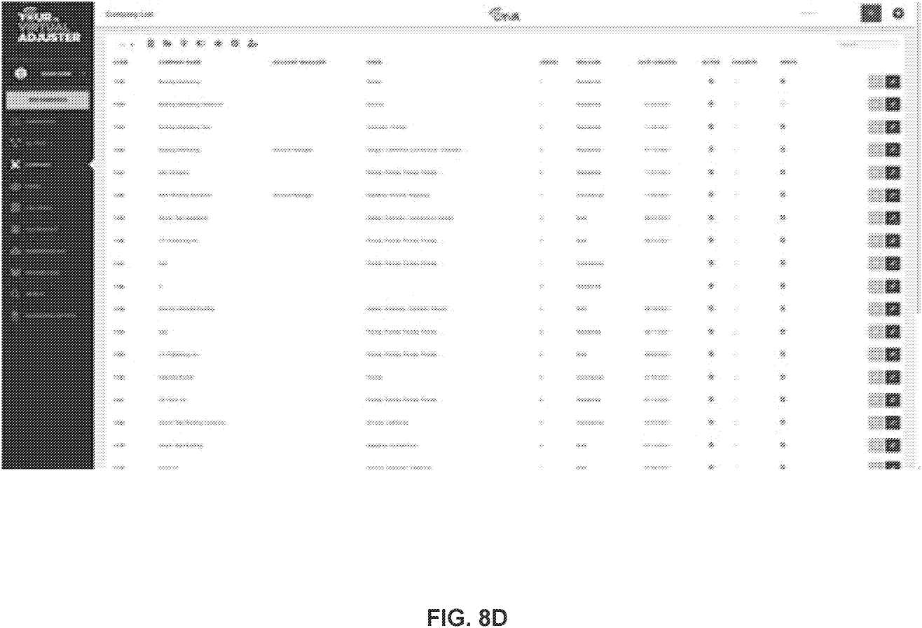

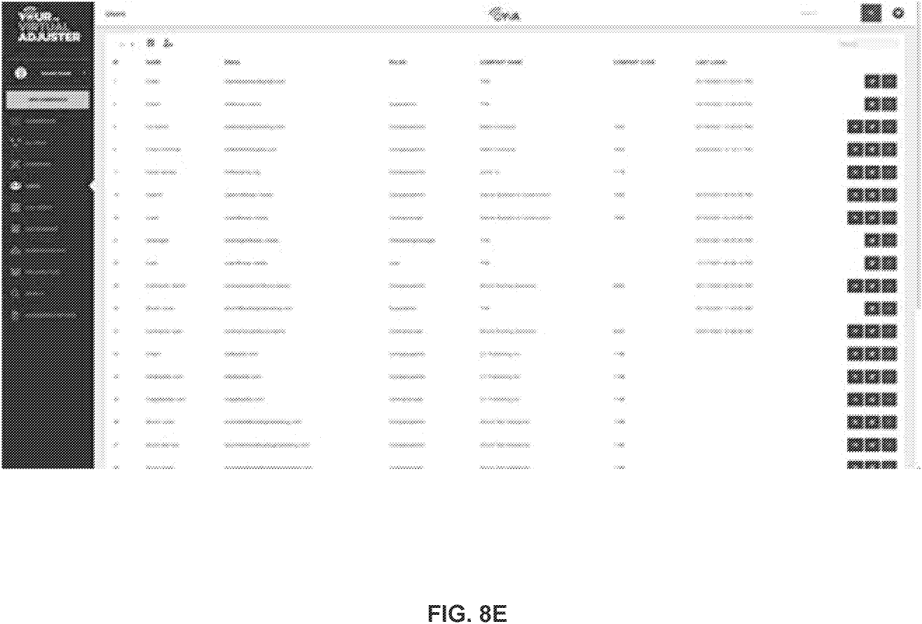

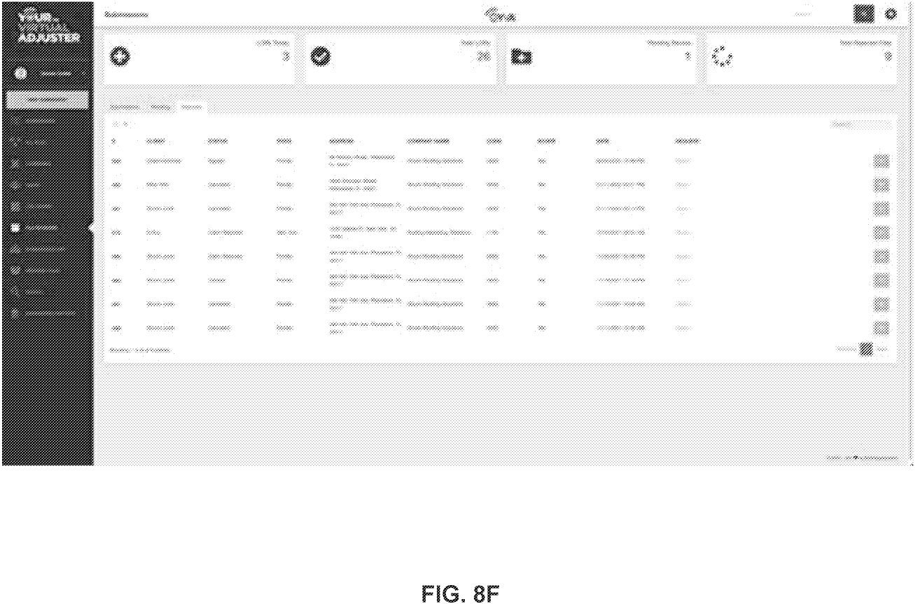

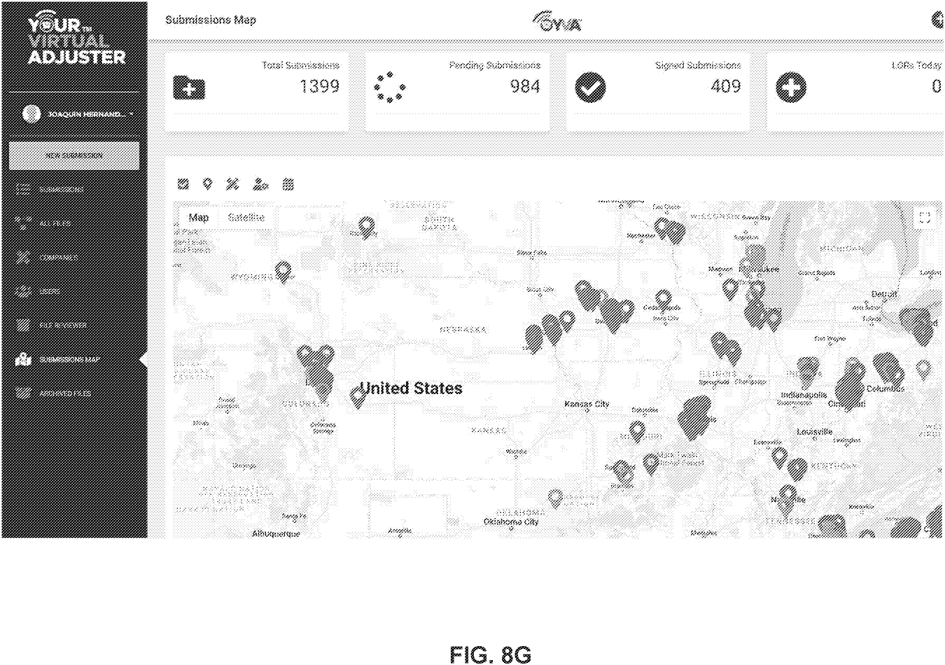

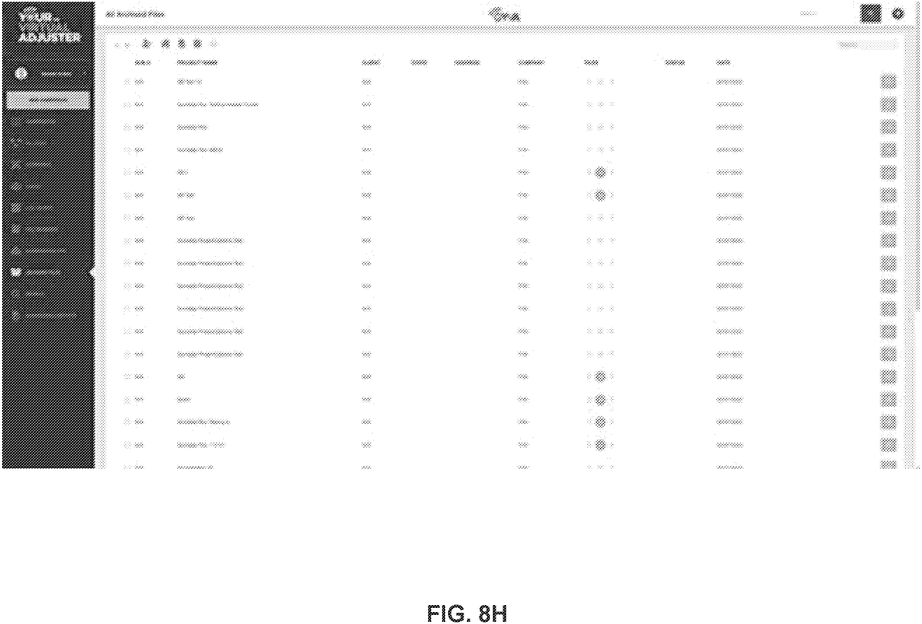

FIGS. 8A, 8B, 8C, 8D, 8E, 8F, 8G, and 8H illustrate portions of an exemplary dashboard interface that may be displayed, for example, by IA computing device 102. The executed dashboard interface may be a web-based application, for example, and provides for display at least portions of customer information, insurance information, and damage information, including estimated repair and replacement cost information (e.g., received from claim information messages 310 and additional information response messages 313), as well as determined claim amounts and claim status, as described herein.

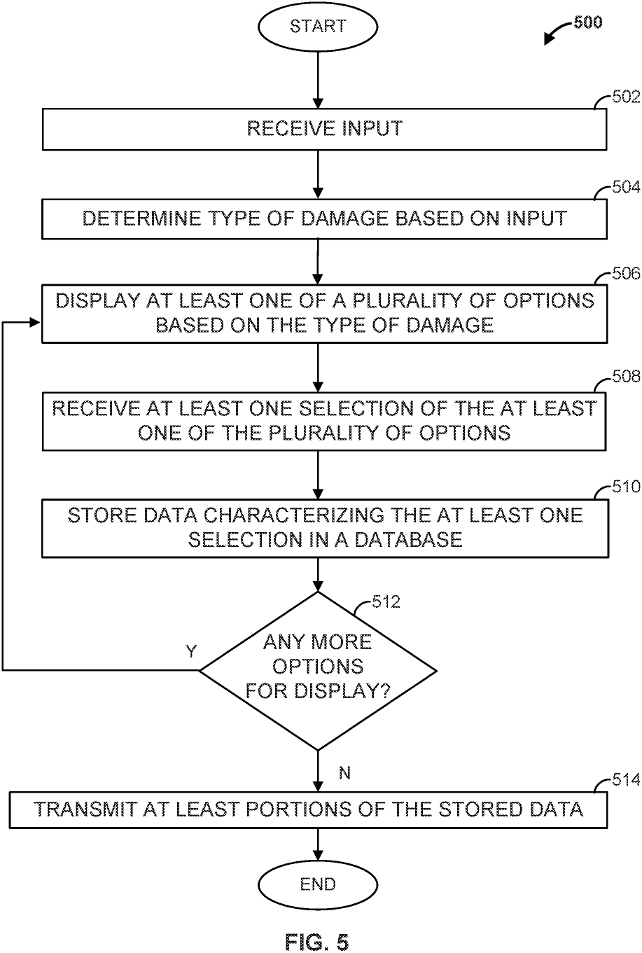

FIG. 5 illustrates a flowchart of an example method 500 that may be carried out by, for example, the contractor computing device 112, 114 of FIG. 1. Beginning at step 502, input is received. For example, a contractor may provide input to a user interface 205 of display 206 (e.g., using I/O device 203). At step 504, the contractor computing device 112, 114 determines a type of damage based on the input. For example, user interface 205 may provide a plurality of icons, where each icon corresponds to a type of damage. For instance, a first icon may correspond to roof damage, a second icon may correspond to window damage, and a third icon may correspond to flood damage. Contractor computing device 112, 114 may determine the type of damage based on an icon the contractor engages (e.g., clicked on).

Proceeding to step 506, contractor computing device 112, 114 displays at least one of a plurality of options based on the type of damage. For example, contractor computing device 112, 114 may display an interface that allows for a selection of one or more attributes of the damaged roof, the damaged window, or the flooded property, depending on the type of damage selected. As another example, for window damage, contractor computing device 112, 114 may display an interface that allows for a selection of how many windows were damaged. At step 508, contractor computing device 112, 114 receives at least one selection of the at least one of the plurality of options. For example, the contractor may select, for roof damage, a type of roofing material (e.g., tile, wood, slate, etc.), an age of the roof, and a construction type of the roof.

At step 510, contractor computing device 112, 114 stores data characterizing the selections (e.g., damage information) in a database, such as database 320. At step 512, contractor computing device 112, 114 determines whether there are any more options for display. For example, contractor computing device 112, 114 may determine that, for window damage, information is needed for a second window that was damaged, such as the location of the second window, a type of glass of the second window, or any other suitable information. If any more options are to be displayed, the method proceeds back to step 506. Otherwise, if no more options are to be displayed, the method proceeds to step 514, where at least portions of the stored data is transmitted. For example, contractor computing device 112, 114 may package at least portions of the stored data within a claim information message 310, and may transmit the claim information message 310 to IA computing device 102. The method then ends.

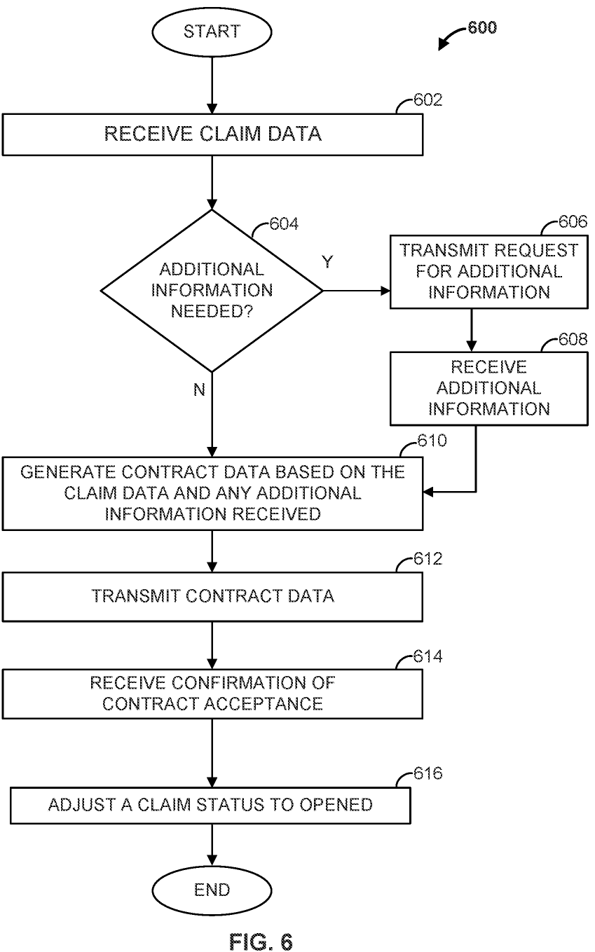

FIG. 6 illustrates a flowchart of an example method 500 that may be carried out by, for example, IA computing device of FIG. 1. Beginning at step 602, claim data is received. For example, IA computing device 102 may receive a claim information message 310 from a contractor computing device 112, 114. At step 604, IA computing device 102 determines whether additional information is needed to generate a digital contract. If no additional information is needed, the method proceeds to step 610.

If, however, additional information is needed, the method proceeds to step 606, where IA computing device 102 generates and transmits a request for the additional information. For example, IA computing device 102 may generate an additional information request message 312, and may transmit the additional information request message 312 to the contractor computing device 112, 114. At step 608, the additional information is received. For example, IA computing device 102 may receive an additional information response message 313 from the contractor computing device 112, 114. The method then proceeds to step 610.

At step 610, IA computing device 102 generates contract data based on the claim data and any additional information received. For example, IA computing device 102 may generate a digital contract based on information received within any claim information message 310 and additional information request message 312 as described herein. Further, and at step 612, IA computing device 102 transmit the contract data. For example, IA computing device 102 may transmit the contract data characterizing a digital contract to a device of an owner of a property 113, 115. In some examples, IA computing device 102 sends a short message service (SMS) message (e.g., text) to the device of the owner, where the SMS message includes a link to the digital contract. In some examples, IA computing device 102 sends an email with a link to the digital contract. The email may be sent to an email address of the owner of the property.

Proceeding to step 614, IA computing device 102 receives a confirmation of contract acceptance. For example, IA computing device 102 may receive an indication that the digital contract was digitally signed, such as an email. At step 616, IA computing device 102 adjusts a claim status to “RECEIVED.” For example, upon receiving confirmation of the signed digital contract, IA computing device 102 may adjust the corresponding claim status 358 for the owner of the property 113, 115 to “RECEIVED,” thereby indicating that the owner has agreed to be represented by insurance adjusting company 103. In some examples, after the claim has been approved, IA computing device 102 may adjust the claim status 358 to another value to indicate “OPENED.” The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A computing device comprising at least one processor configured to:
receive input data;
determine a type of damage based on the input data;
provide for display a plurality of options based on the type of damage;
receive additional input data characterizing at least one selection of the plurality of options;
generate a message based on the input data and the additional input data; and
transmit the message.

2. The computing device of claim 1 wherein generating the message comprises generating an identifier, wherein the message includes the identifier.

3. The computing device of claim 1 wherein the type of damage comprises at least one of: roof damage, window damage, and flooding damage.

4. The computing device of claim 1 wherein the at least one processor is further configured to receive at least one image, and wherein generating the message comprises including the at least one image in the message.

5. A computing device comprising at least one processor and communicatively coupled to a database, the at least one processor configured to:
receive data characterizing damage to a property;
determine, based on the data, whether additional data is needed to generate a digital contract;
generate the digital contract based on the data;
transmit the digital contract;
receive an indication of whether the digital contract was digitally signed; and
adjust a claim status value within the database based on the indication.

6. The computing device of claim 5, wherein the at least one processor is further configured to determine a claim amount based on the data.

7. The computing device of claim 6, wherein determining the claim amount comprises:
generating features based on the data; and
applying a trained machine learning model to the generated features.

8. The computing device of claim 5, wherein the data comprises customer information, damage information, and insurance information.

9. The computing device of claim 5, wherein the at least one processor is further configured to:
determine that additional data is needed to generate the digital contract;
transmit a request for the additional data;
receive the additional data; and
generate the digital contract based on the additional data.

10. The computing device of claim 5, wherein the data comprises estimated costs.

11. A method by at least one processor comprising:
receiving input data;
determining a type of damage based on the input data;
providing for display a plurality of options based on the type of damage;
receiving additional input data characterizing at least one selection of the plurality of options;
generating a message based on the input data and the additional input data; and
transmitting the message.

12. The method of claim 11 wherein generating the message comprises generating an identifier, wherein the message includes the identifier.

13. The method of claim 11 wherein the type of damage comprises at least one of: roof damage, window damage, and flooding damage.

14. The method of claim 11 further comprising receiving at least one image, and wherein generating the message comprises including the at least one image in the message.

15. The method of claim 11 further comprising:
receiving data characterizing damage to a property in response to transmitting the message;
generating a digital contract based on the data;
transmitting the digital contract;
receiving an indication of whether the digital contract was digitally signed; and
adjusting a claim status value within a database based on the indication.

16. The method of claim 15 further comprising determining a claim amount based on the data.

17. The method of claim 15, wherein determining the claim amount comprises:
generating features based on the data; and
applying a trained machine learning model to the generated features.

18. The method of claim 15, wherein the data comprises customer information, damage information, and insurance information.

19. The method of claim 15 further comprising:
determining that additional data is needed to generate the digital contract;
transmitting a request for the additional data;
receiving the additional data; and
generating the digital contract based on the additional data.

20. The method of claim 15 wherein the data comprises estimated costs.
